(19) United States
(12) Patent Application Publication
(10) Pub. No.: US 2017/0358792 A1
(43) Pub. Date: Dec. 14, 2017

(54) METHOD OF MANUFACTURING NONAQUEOUS ELECTROLYTE SECONDARY BATTERY AND NONAQUEOUS ELECTROLYTE SECONDARY BATTERY

(71) Applicant: TOYOTA JIDOSHA KABUSHIKI KAISHA, Toyota-shi, Aichi-ken (JP)

(72) Inventors: Hiroya UMEYAMA, Okazaki-shi, Aichi-ken (JP); Yuji YOKOYAMA, Moriguchi-shi, Osaka (JP); Naoyuki WADA, Hirakata-shi, Osaka (JP); Yusuke FUKUMOTO, Toyonaka-shi, Osaka (JP); Tatsuya HASHIMOTO, Osaka-shi, Osaka (JP)

(73) Assignee: TOYOTA JIDOSHA KABUSHIKI KAISHA, Toyota-shi, Aichi-ken (JP)

(21) Appl. No.: 15/537,518

(22) PCT Filed: Dec. 18, 2015
(86) PCT No.: PCT/IB2015/002377

§ 371 Date: Jun. 19, 2017

(30) Foreign Application Priority Data
Dec. 19, 2014 (JP) 2014-257567

(51) Int. Cl. H01M 4/1393; H01M 10/0525; H01M 4/583; H01M 4/133; H01M 4/36; H01M 4/62; H01M 4/38; H01M 4/02

(52) U.S. Cl. CPC H01M 4/1393; H01M 4/628; H01M 10/0525; H01M 4/382; H01M 4/583; H01M 4/133; H01M 4/366; H01M 4/621; H01M 2004/027

(57) ABSTRACT

A method of manufacturing a nonaqueous electrolyte secondary battery includes: a kneading step of kneading a carbon-based negative electrode active material, a binder, and a sugar alcohol with each other to form a negative electrode mixture paste; and an application step of applying the negative electrode mixture paste to a negative electrode current collector to form a negative electrode mixture layer.

### BACKGROUND OF THE INVENTION

### 1. Field of the Invention

The invention relates to a method of manufacturing a nonaqueous electrolyte secondary battery and a nonaqueous electrolyte secondary battery.

### 2. Description of Related Art

Japanese Patent Application Publication No. 2007-250424 (JP 2007-250424 A) discloses a nonaqueous electrolyte secondary battery in which an electrolyte contains a sugar alcohol fatty acid ester compound in an amount of 1 wt % to a saturated solubility.

In JP 2007-250424 A, the sugar alcohol fatty acid ester compound is added to a liquid electrolyte, that is, an electrolytic solution. According to this configuration, when a battery is overcharged, lithium (Li) metal deposited on a negative electrode reacts with the sugar alcohol fatty acid ester compound, and thus lithium metal can be inactivated. As a result, the improvement of safety during overcharge can be expected. However, according to this configuration, battery resistance increases.

### SUMMARY OF THE INVENTION

According to the invention, an increase in battery resistance can be suppressed while improving safety during overcharge.

According to a first aspect of the invention, there is provided a method of manufacturing a nonaqueous electrolyte secondary battery, the method including: a kneading step of kneading a carbon-based negative electrode active material, a binder, and a sugar alcohol with each other to form a negative electrode mixture paste; and an application step of applying the negative electrode mixture paste to a negative electrode current collector to form a negative electrode mixture layer.

When a sugar alcohol fatty acid ester compound is added to an electrolytic solution as in the case of the related art, an increase in battery resistance is expected due to the following reasons. The electrolytic solution permeates not only into a negative electrode mixture layer but also into a positive electrode mixture layer. Accordingly, the sugar alcohol fatty acid ester compound also permeates into the positive electrode mixture layer. The sugar alcohol fatty acid ester compound cannot withstand a positive electrode potential and is decomposed to form a resistance film. As a result, the battery resistance increases. In addition, the amount of a sugar alcohol supplied to the negative electrode mixture layer also decreases.

The permeation of the electrolytic solution into the negative electrode mixture layer is not likely to be uniform. That is, the distribution of the sugar alcohol fatty acid ester compound in the negative electrode mixture layer is not likely to be uniform. Therefore, it is presumed that, in a portion of the negative electrode mixture layer where the abundance of the sugar alcohol in the negative electrode mixture layer is small, the inactivation of lithium metal is insufficient. In particular, during high-rate (high-current) overcharge, the amount of lithium metal deposited increases, the effect thereof is a concern.

On the other hand, in the above-described method, due to the following reasons, an increase in battery resistance can be suppressed while improving safety during overcharge. In the above-described method, the sugar alcohol itself is used instead of the sugar alcohol fatty acid ester compound. The sugar alcohol is kneaded with the carbon-based negative electrode active material to form the negative electrode mixture paste. Using the negative electrode mixture paste, the negative electrode mixture layer containing the sugar alcohol is formed. As a result, in the negative electrode mixture layer, the sugar alcohol can be uniformly distributed. Moreover, the sugar alcohol has high affinity to the carbon-based negative electrode active material. Therefore, the elution of the sugar alcohol from the negative electrode mixture layer is suppressed. Furthermore, in order for the sugar alcohol to permeate into the positive electrode mixture layer, it is necessary that the sugar alcohol move to the positive electrode mixture layer side after being dissolved in the electrolytic solution. Therefore, an increase in resistance caused by the permeation of the sugar alcohol into the positive electrode mixture layer can be suppressed.

The sugar alcohol may be at least one selected from the group consisting of mannitol, xylitol, sorbitol, and maltitol. The reason for this is that the improvement of safety during overcharge can be expected from the above sugar alcohols.

A mixing amount of the sugar alcohol is 0.1 parts by mass to 7.0 parts by mass with respect to 100 parts by mass of the carbon-based negative electrode active material. The reason for this is that, with the above-described range, the improvement of safety during overcharge can be expected.

The kneading step may include: a first kneading step of kneading the binder, the sugar alcohol, a thickener, and a solvent with each other to obtain a first mixture; a second kneading step of kneading the first mixture and the carbon-based negative electrode active material with each other to obtain a second mixture; and a dilution-dispersion step of adding the solvent to the second mixture and kneading the solvent and the second mixture with each other to obtain the negative electrode mixture paste. With the above-described configuration, the uniformity of the sugar alcohol distribution in the negative electrode mixture layer may be improved.

According to a second aspect of the invention, there is provided a nonaqueous electrolyte secondary battery including: a negative electrode current collector; and a negative electrode mixture layer that is formed on the negative electrode current collector. The negative electrode mixture layer contains a carbon-based negative electrode active material, a binder, and a sugar alcohol. When a section of the negative electrode mixture layer in a thickness direction is divided into six measurement regions by trisecting the negative electrode mixture layer in a width direction and further bisecting the negative electrode mixture layer in the thickness direction, all the measurement regions satisfy the following expression (I).

0.8<Mᵢ/Mₐᵥₑ<1.2 (I)

In the expression (I), i represents an integer of 1 to 6, Mᵢ represents an NMR signal intensity of the sugar alcohol in each of the measurement regions, and Mₐᵥₑ represents an average value of M₁, M₂, M₃, M₄, M₅, and M₆.

As described above, by controlling the distribution of the sugar alcohol in the negative electrode mixture layer, the safety during overcharge can be improved.

The average value (Mₐᵥₑ) may be 10 to 700. As a result, the improvement of safety during overcharge can be expected.

According to the above-described aspects, an increase in battery resistance can be suppressed while improving safety during overcharge.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flowchart showing the summary of a method of manufacturing a nonaqueous electrolyte secondary battery according to an embodiment of the invention;

FIG. 2 is a flowchart showing the summary of a negative electrode preparation step according to the embodiment of the invention;

FIG. 3 is a schematic diagram showing a configuration example of a negative electrode according to the embodiment of the invention;

FIG. 4 is a schematic sectional view taken along line IV-IV of FIG. 3;

FIG. 5 is a schematic diagram showing a configuration example of a positive electrode according to the embodiment of the invention;

FIG. 6 is a schematic diagram showing a configuration example of an electrode group according to the embodiment of the invention;

FIG. 7 is a schematic diagram showing a configuration example of a nonaqueous electrolyte secondary battery according to the embodiment of the invention;

FIG. 8 is a schematic sectional view taken along line VIII-VIII of FIG. 7;

FIG. 9 is a table showing preparation conditions of Sample A1; and

FIG. 10 is a table showing the NMR measurement results of each sample.

### DETAILED DESCRIPTION OF EMBODIMENTS

Hereinafter, an embodiment of the invention (hereinafter, referred to as “the embodiment”) will be described in detail. However, the embodiment is not limited to the following description.

[Method of Manufacturing Nonaqueous Electrolyte Secondary Battery]

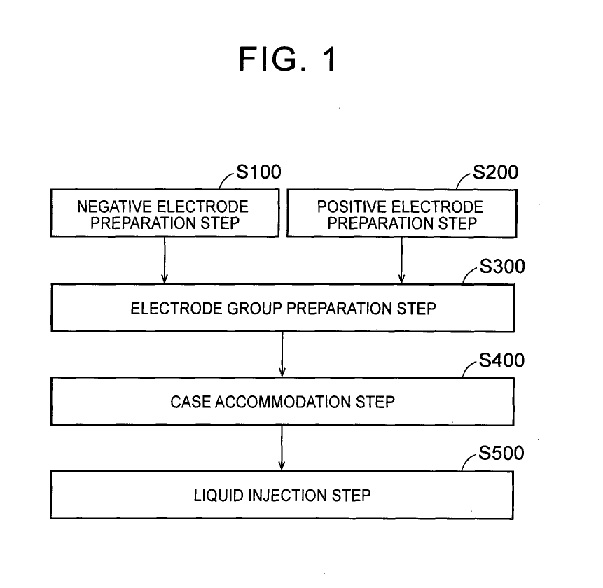

FIG. 1 is a flowchart showing the summary of a method of manufacturing a nonaqueous electrolyte secondary battery according to the embodiment. As shown in FIG. 1, the manufacturing method includes, a negative electrode preparation step (S100), a positive electrode preparation step (S200), an electrode group preparation step (S300), a case accommodation step (S400), and a liquid injection step (S500). Hereinafter, each step will be described.

[Negative Electrode Preparation Step (S100)]

The negative electrode preparation step includes: a kneading step of kneading a carbon-based negative electrode active material (hereinafter, also referred to simply as “negative electrode active material”), a binder, and a sugar alcohol with each other to form a negative electrode mixture paste; and an application step of applying the negative electrode mixture paste to a negative electrode current collector to form a negative electrode mixture layer.

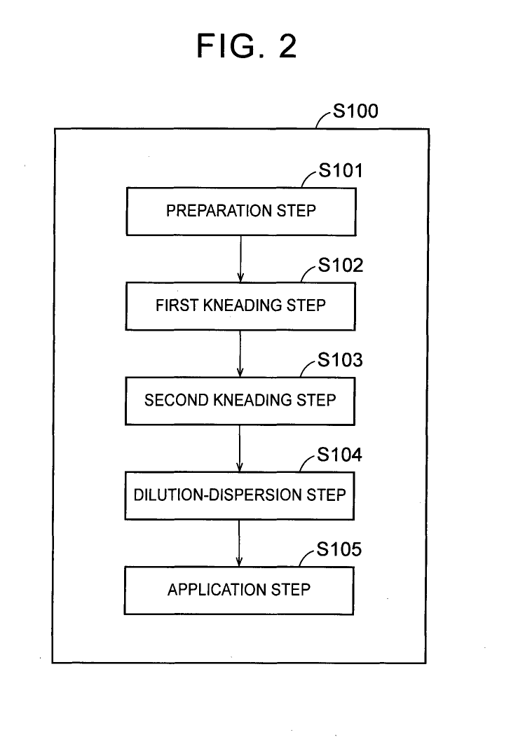

FIG. 2 is a flowchart showing the summary of the negative electrode preparation step. As shown in FIG. 2, the negative electrode preparation step includes a preparation step (S101), a first kneading step (S102), a second kneading step (S103), a dilution-dispersion step (S104), and an application step (S105). Among these steps, the steps from the first kneading step to the dilution-dispersion step correspond to the kneading step.

[Preparation Step (S101)]

In the preparation step (S101), the respective materials including the sugar alcohol, the negative electrode active material, the thickener, and the binder are prepared.

[Sugar Alcohol]

The sugar alcohol is a polyol which is produced by an aldehyde group of sugar being reduced. The sugar alcohol is in the form of a powder or a solution. The sugar alcohol may be, for example, mannitol, xylitol, sorbitol, maltitol, lactitol, or oligosaccharide alcohol. In particular, when mannitol, xylitol, sorbitol, or maltitol is used, the improvement of safety during overcharge can be expected. Among these, one kind may be used alone, or two or more kinds may be used in combination as the sugar alcohol. That is, the sugar alcohol may be at least one selected from the group consisting of mannitol, xylitol, sorbitol, and maltitol.

The sugar alcohol may have a chain structure or a ring structure. In consideration of reactivity with lithium metal, it is preferable that the sugar alcohol has a chain structure. Due to the same reason, it is preferable that the valence of the sugar alcohol is 5 to 6. The valence refers to the number of alcoholic hydroxy groups present in the molecular structure of the sugar alcohol. In consideration the above-described conditions, it is preferable that the sugar alcohol is at least one selected from the group consisting of mannitol, xylitol, and sorbitol.

The sugar alcohol is highly hydrophilic due to the alcoholic hydroxy group. Therefore, water is preferable as a solvent during the preparation of the paste because the dispersibility of the sugar alcohol is improved. The mixing amount of the sugar alcohol in the negative electrode mixture may be 0.1 parts by mass to 7.0 parts by mass with respect to 100 parts by mass of the carbon-based negative electrode active material. Within the above-described range, the improvement of safety during overcharge can be expected. The lower limit of the mixing amount may be 0.3 parts by mass or 1.0 part by mass. The upper limit of the mixing amount may be 5.0 parts by mass or 4.0 parts by mass. Within the above-described ranges, the safety during overcharge can be significantly improved.

[Negative Electrode Active Material]

In the embodiment, the carbon-based negative electrode active material is used. The carbon-based negative electrode active material is a carbon material capable of storing and releasing Li ions. For example, natural graphite, artificial graphite, or coke can be used as the carbon-based negative electrode active material. The carbon-based negative electrode active material has high affinity to the sugar alcohol. Accordingly, by adopting the carbon-based negative electrode active material, the elution of the sugar alcohol from the negative electrode mixture layer can be suppressed.

[Thickener]

The thickener imparts adhesiveness to the negative electrode mixture paste. As a result, the state where the negative electrode active material is dispersed in the negative electrode mixture paste can be stabilized. The dried thickener has a function of bonding particles of the negative electrode active material to each other or bonding the negative electrode active material to the negative electrode current collector. When water is used as the solvent, for example, carboxymethyl cellulose (CMC), polyvinyl alcohol (PVA), polyethylene oxide (PEO), or polyacrylic acid (PAA) can be used as the thickener. The mixing amount of the thickener in the negative electrode mixture may be, for example, about 0.5 parts by mass to 2.0 parts by mass with respect to 100 parts by mass of the negative electrode active material.

[Binder]

The binder is not particularly limited as long as it can bond particles of the negative electrode active material to each other or can bond the negative electrode active material to the negative electrode current collector. It is preferable that the binder has superior dispersibility in water. The binder may be, for example, styrene-butadiene rubber (SBR), acrylic rubber (AR), or urethane rubber (UR). The mixing amount of the binder in the negative electrode mixture may be, for example, about 0.5 parts by mass to 2.0 parts by mass with respect to 100 parts by mass of the negative electrode active material.

[First Kneading Step (S102)]

In the first kneading step, the binder, the sugar alcohol, the thickener, and the solvent are kneaded with each other to obtain a first mixture. A kneading machine is not particularly limited. The kneading machine may be, for example, a planetary mixer. Kneading conditions may be appropriately adjusted based on, for example, the batch amount, the powder properties, and the composition. For example, the binder, the sugar alcohol, the thickener, and the solvent may be put into a planetary mixer and may be kneaded with each other for a predetermined amount of time. As a result, the first mixture is obtained. By dispersing or dissolving the sugar alcohol in the solvent in advance as described above, the sugar alcohol is likely to be attached to the carbon-based negative electrode active material.

[Second Kneading Step (S103)]

In the second kneading step, the first mixture and the carbon-based negative electrode active material are kneaded with each other to obtain a second mixture. Specifically, the carbon-based negative electrode active material may be additionally put into the planetary mixer, and the components may be kneaded with each other for a predetermined amount of time. As a result, the second mixture is obtained. The solid content proportion of the second mixture may be about 60 mass % to 80 mass %. By kneading the respective materials into a so-called thick paste, the dispersibility of the respective materials can be improved. Here, the solid content proportion refers to the mass proportion of components of the mixture excluding liquid (solvent).

[Dilution-Dispersion Step (S104)]

In the dilution-dispersion step, the solvent is added to the second mixture, and the solvent and the second mixture are kneaded with each other to obtain the negative electrode mixture paste. Specifically, water may be additionally put into the planetary mixer, and the components may be kneaded with each other for a predetermined amount of time. As a result, the negative electrode mixture paste is obtained. At this time, the solid content proportion of the negative electrode mixture paste may be about 45 mass % to 55 mass %. Next, the negative electrode mixture paste may undergo a treatment such as degassing or mesh passing.

[Application Step (S105)]

In the application step (S105), the negative electrode mixture paste is applied to a predetermined position on the negative electrode current collector. As a result, the negative electrode mixture layer is formed. An application method is not particularly limited. The application method may be, for example, gravure printing or die coating. The coating mass may be appropriately adjusted based on the battery specification. The paste coating film can be dried using, for example, a hot air drying furnace. The negative electrode mixture layer may be formed on both main surfaces (front and back surfaces) of the negative electrode current collector. The negative electrode current collector is, for example, a copper (Cu) foil.

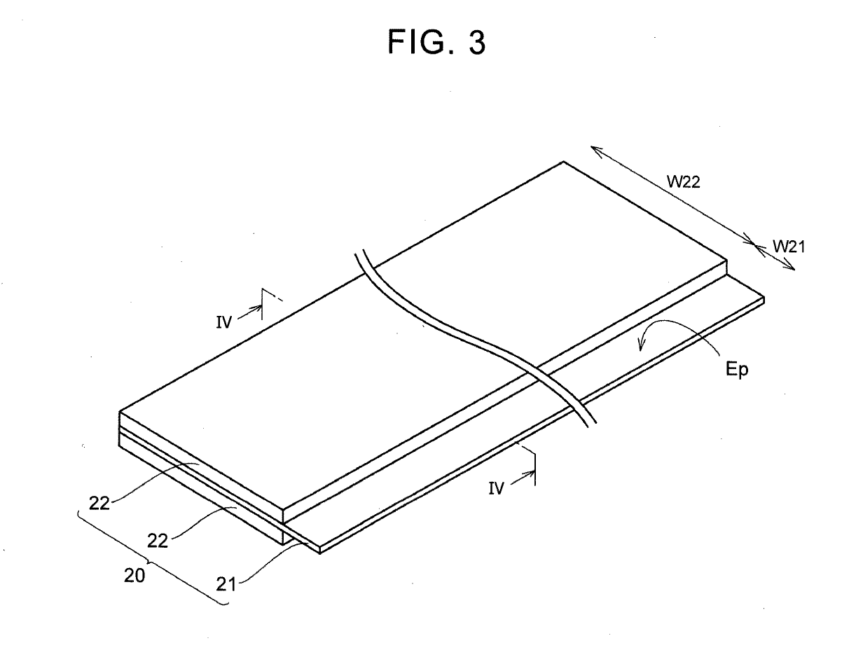

Next, the thickness of the negative electrode mixture layer is adjusted using a rolling mill or the like. Using a slitter or the like, the negative electrode mixture layer and the negative electrode current collector are processed to have a predetermined dimension. In this way, a negative electrode 20 shown in FIG. 3 is completed. An exposure portion Ep where a negative electrode current collector 21 is exposed is provided for connection to an external terminal.

[Positive Electrode Preparation Step (S200)]

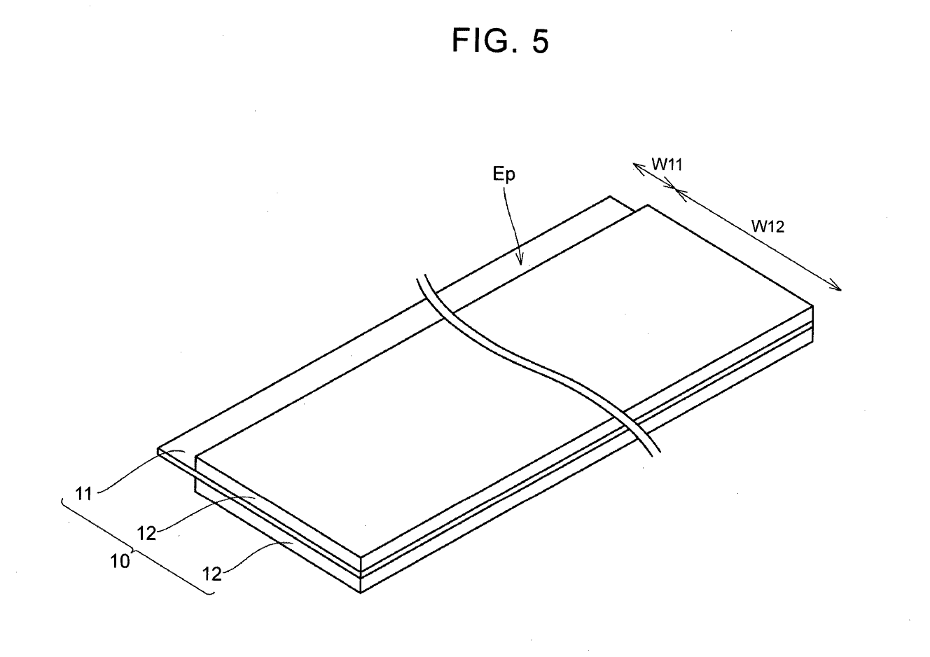

In the positive electrode preparation step, a positive electrode 10 shown in FIG. 5 is prepared. The positive electrode 10 includes: a positive electrode current collector 11; and a positive electrode mixture layer 12 that is arranged on both main surfaces of the positive electrode current collector 11. In the positive electrode 10, an exposure portion Ep where the positive electrode current collector 11 is exposed is provided for connection to an external terminal. The positive electrode current collector 11 is, for example, an aluminum (Al) foil.

The positive electrode 10 can be prepared, for example, as follows. The positive electrode active material, a conductive material, and a binder are kneaded with each other in a solvent to obtain a positive electrode mixture paste. The positive electrode mixture paste is applied to a predetermined position on the positive electrode current collector 11. By drying the paste coating film, the positive electrode mixture layer 12 is formed. The positive electrode mixture layer 12 is rolled to adjust the thickness. The positive electrode mixture layer 12 and the positive electrode current collector 11 are processed to have a predetermined dimension.

The positive electrode active material may be a material capable of storing and releasing Li ions. For example, a Li-containing composite oxide can be used as the positive electrode active material. Specifically, for example, LiCoO₂, LiNiO₂, LiNiₐCo_{b}O₂ (wherein, a+b=1, 0<a<1, and 0<b<1), LiMnO₂, LiMn₂O₄, LiNiₐCo_{b}Mn_{c}O₂ (wherein, a+b+c=1, 0<a<1, 0<b<1, and 0<c<1), or LiFePO₄ can be used as the positive electrode active material.

For example, the conductive material may be amorphous carbon such as acetylene black (AB) or graphite. The mixing amount of the conductive material may be, for example, about 1 parts by mass to 10 parts by mass with respect to 100 parts by mass of the positive electrode active material. The binder may be, for example, polyvinylidene fluoride (PVDF) or polytetrafluoroethylene (PTFE). The mixing amount of the binder may be, for example, about 1 parts by mass to 10 parts by mass with respect to 100 parts by mass of the positive electrode active material.

[Electrode Group Preparation Step (S300)]

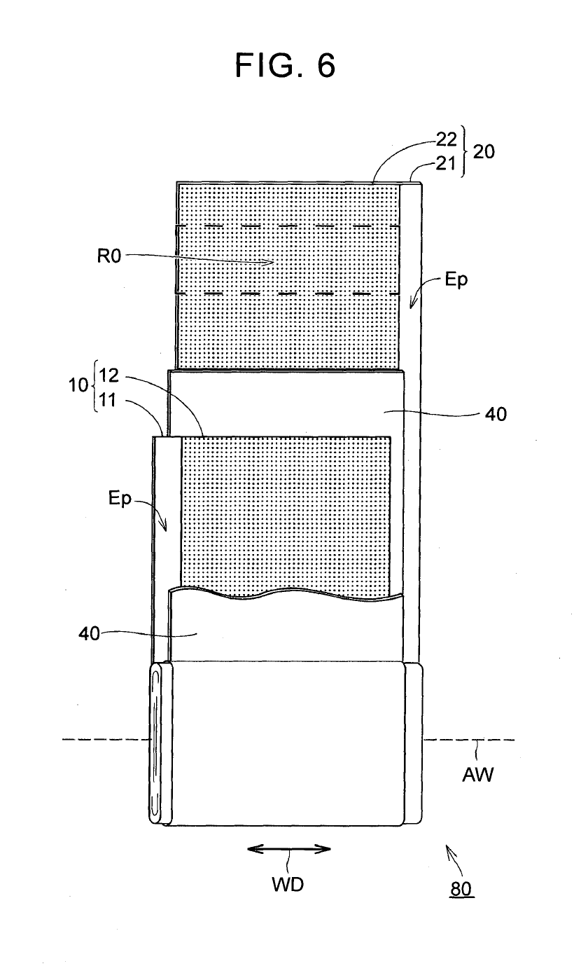

In the electrode group preparation step, an electrode group 80 shown in FIG. 6 is prepared. The electrode group 80 includes separators 40, the positive electrode 10, and the negative electrode 20.

The electrode group 80 is a wound electrode group. That is, the electrode group 80 is prepared by arranging the positive electrode 10 and the negative electrode 20 to face each other with the separators 40 therebetween and winding the components around a winding axis AW. At this time, the portions Ep where the current collectors are exposed are arranged at end portions in a width direction WD. After being wound, the electrode group 80 is formed into a flat shape.

The separator prevents electrical contact between the positive electrode 10 and the negative electrode 20 while allowing penetration of Li ions. For example, the separator may be a microporous membrane formed of polyethylene (PE), polypropylene (PP), or the like.

The separator may be obtained by laminating plural microporous membranes. A heat resistance layer containing an inorganic filler (for example, alumina particles) may be formed on a surface of the separator. The thickness of the separator may be, for example, 5 μm to 40 μm. The pore size and porosity of the separator may be appropriately adjusted such that the air permeability is a desired value.

[Case Accommodation Step (S400)]

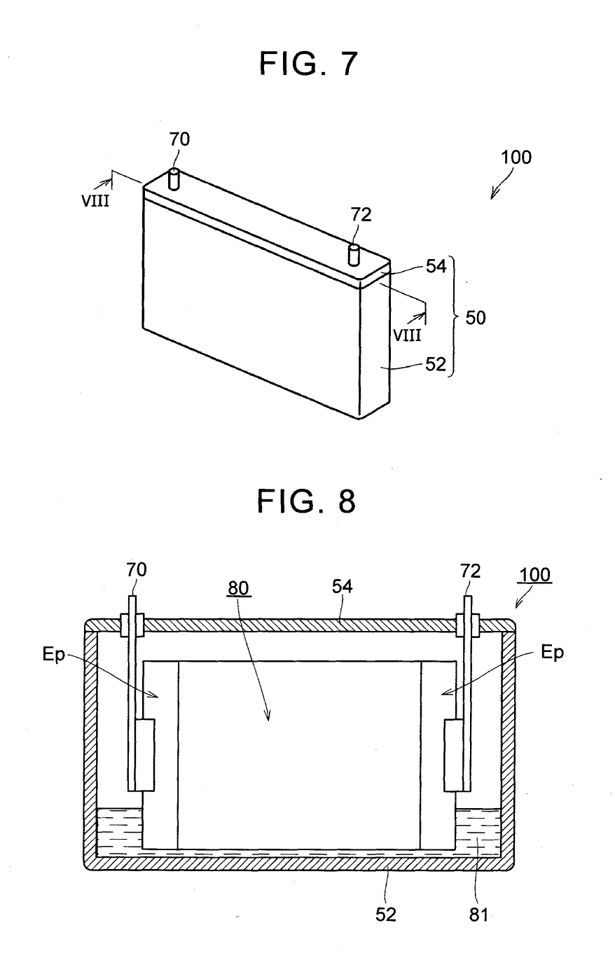

In the case accommodation step, the electrode group is accommodated in an external case. As shown in FIG. 7, an external case 50 includes, for example, a bottomed square case body 52 and a sealing plate 54. A positive electrode terminal 70 and a negative electrode terminal 72 are provided on the sealing plate 54. In the external case, for example, a liquid injection hole, a safety valve, and a current interrupt device (all of which are not shown) may be provided. The external case is formed of, for example, an Al alloy.

FIG. 8 is a schematic sectional view taken along line VIII-VIII of FIG. 7. As shown in FIG. 8, the electrode group 80 is accommodated in the external case 50. At this time, the electrode group 80 is connected to the positive electrode terminal 70 and the negative electrode terminal 72 in the portions Ep where the current collectors are exposed.

[Liquid Injection Step (S500)]

In the liquid injection step, the electrolytic solution is injected into the external case. An electrolytic solution 81 can be injected, for example, through a liquid injection hole provided on the external case 50. After the injection, the liquid injection hole is sealed using predetermined means. The electrolytic solution 81 is impregnated into the electrode group 80. At this time, in the wound electrode group, the electrolytic solution is not likely to permeate into the electrode group, and the permeation may be non-uniform. The residue of the electrolytic solution 81 which is not impregnated into the electrode group 80 remains in the external case 50.

The electrolytic solution is a liquid electrolyte in which a supporting electrolyte is dissolved in a nonaqueous solvent. The nonaqueous solvent may be: a cyclic carbonate such as ethylene carbonate (EC), propylene carbonate (PC), butylene carbonate (BC), or γ-butyrolactone (γBL); or may be a chain carbonate such as dimethyl carbonate (DMC), ethyl methyl carbonate (EMC), or diethyl carbonate (DEC). Among these nonaqueous solvents, a combination of two or more kinds may be used. From the viewpoint of electrical conductivity and electrochemical stability, it is preferable that a mixture of a cyclic carbonate and a chain carbonate is used. At this time, a volume ratio of the cyclic carbonate to the chain carbonate may be about 1:9 to 5:5.

The supporting electrolyte may be, for example, Li salts such as LiPF₆, LiBF₄, LiClO₄, LiAsF₆, Li(CF₃SO₂)₂N, or LiCF₃SO₃. Among these supporting electrolytes, a combination of two or more kinds may be used. The concentration of the supporting electrolyte in the electrolytic solution may be about 0.5 mol/L to 2.0 mol/L.

[Nonaqueous Electrolyte Secondary Battery]

Using the above-described method, a battery 100 shown in FIG. 7 is manufactured. In a negative electrode mixture layer 22 contained in the battery 100, the sugar alcohol is uniformly distributed. As a result, the improvement of safety during overcharge can be expected. The amount of the sugar alcohol permeating into the positive electrode mixture layer 12 is small. Therefore, an increase in resistance caused by the sugar alcohol in the positive electrode mixture layer 12 being decomposed can be suppressed.

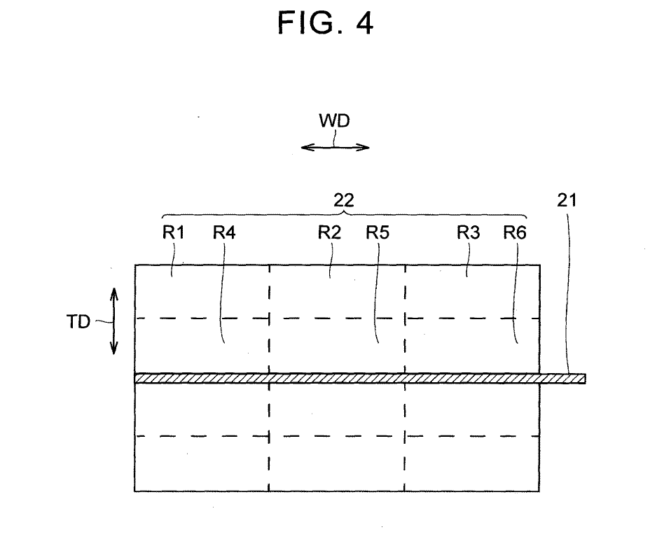

FIG. 4 is a schematic sectional view taken along line IV-IV of FIG. 3. As shown in FIG. 4, the nonaqueous electrolyte secondary battery according to the embodiment includes: the negative electrode current collector 21; and the negative electrode mixture layer 22 that is formed on the negative electrode current collector 21. The negative electrode mixture layer 22 contains the carbon-based negative electrode active material, the binder, and the sugar alcohol. The uniformity of the sugar alcohol distribution in the negative electrode mixture layer 22 can be evaluated as follows.

First, a section of the negative electrode mixture layer 22 shown in FIG. 4 in a thickness direction is obtained. This section is divided into six measurement regions. That is, the section in the thickness direction is bisected in the thickness direction TD and is further trisected in the width direction WD. As a result, measurement regions R1 to R6 are obtained. When the planar shape of the negative electrode mixture layer 22 is rectangular, the width direction WD refers to a direction moving along the width of the rectangle on the short side.

For the identification and quantitative analysis of the sugar alcohol, a nuclear magnetic resonance (NMR) method is used. The measurement procedure is as follows. First, the negative electrode mixture is obtained from each of the measurement regions R1 to R6. The negative electrode mixture may be obtained at a position near the center of each of the measurement regions. Next, the negative electrode mixture is dissolved in a deuterated solvent. Examples of the deuterated solvent include deuterated chloroform (CDCl₃) and deuterated dimethyl sulfoxide (CD₃)₂SO). The negative electrode mixture dissolved in the deuterated solvent is analyzed by ¹H-NMR spectroscopy. A reference material is, for example, tetramethylsilane (TMS). By checking the obtained NMR spectrum against the known NMR spectrum database, the sugar alcohol can be identified. A quantitative signal is selected based on the NMR spectrum of the sugar alcohol, and the area of the quantitative signal is obtained as an NMR signal intensity of the sugar alcohol.

In the above-described measurement, for example, an NMR signal intensity obtained from the measurement region R1 is set as M₁. The average value (Mₐᵥₑ) of M₁ to M₆ is calculated. At this time, the absolute quantity may be determined using a calibration curve method. By dividing M₁ to M₆ by Mₐᵥₑ, M₁/Mₐᵥₑ to M₆/Mₐᵥₑ, that is, Mᵢ/Mₐᵥₑ (i represents an integer of 1 to 6) is calculated. At this time, the negative electrode mixture layer 22 according to the embodiment satisfies the above expression (I). On the other hand, for example, when the sugar alcohol is dissolved in the electrolytic solution to permeate into the negative electrode mixture layer, the distribution of the sugar alcohol becomes non-uniform, and the expression (I) is not satisfied. That is, since the electrolytic solution and the sugar alcohol are not likely to permeate into up to the measurement region R5, M₅/Mₐᵥₑ is 0.8 or less. On the other hand, in the measurement regions R1 and R3, the electrolytic solution and the sugar alcohol are likely to remain, and M₁/Mₐᵥₑ and M₃/Mₐᵥₑ are 1.2 or more.

As the thickness and width of the negative electrode mixture layer increase, the above-described tendency becomes more severe. Accordingly, it can be said that the embodiment is efficient on a negative electrode mixture layer having a large thickness and a large width. The thickness of the negative electrode mixture layer may be 50 μm to 200 μm. The lower limit of the thickness may be 75 μm or 100 μm. The upper limit of the thickness may be 150 μm or 125 μm. The width of the negative electrode mixture layer may be 50 mm to 200 mm. The lower limit of the width may be 75 mm. The upper limit of the width may be 150 mm, 125 mm, or 100 mm.

In the expression (I), the lower limit of Mᵢ/Mₐᵥₑ may be 0.81, 0.83, or 0.89. The upper limit of Mᵢ/Mₐᵥₑ may be 1.17, 1.16, or 1.12. As a result, the improvement of safety during overcharge can be expected.

The average value (Mₐᵥₑ) may be 10 to 700. At this time, the mixing amount of the sugar alcohol in the negative electrode mixture layer is, for example, 0.1 parts by mass to 7.0 parts by mass with respect to 100 parts by mass of the negative electrode active material. The average value (Mₐᵥₑ) may be 30 to 500. At this time, the mixing amount of the sugar alcohol in the negative electrode mixture layer is, for example, 0.3 parts by mass to 5.0 parts by mass with respect to 100 parts by mass of the negative electrode active material.

Hereinabove, the embodiment has been described using the square battery as an example. However, the embodiment is not limited to the square battery. The embodiment may be applied to a cylindrical battery or a laminate battery. The electrode group is not limited to the wound electrode group. The electrode group may be a laminated electrode group.

Hereinafter, the embodiment will be described in more detail using Examples. However, the embodiment is not limited to the following Examples.

[Preparation of Nonaqueous Electrolyte Secondary Battery]

Nonaqueous electrolyte secondary batteries (rated capacity: 25 Ah) according to Samples A1 to A8 and Samples B1 to B4 were prepared as follows. Samples A1 to A8 correspond to Examples, and Samples B1 to B4 correspond to Comparative Examples.

[Sample A1]

1. Negative Electrode Preparation Step

1-1. Preparation Step

The following materials were prepared.

Carbon-based negative electrode active material: natural graphite

Thickener: CMC

Binder: SBR

Solvent: water

Sugar alcohol: mannitol

Negative electrode current collector: Cu foil (thickness: 10 μm, width: 80.9 mm).

1-2. First Kneading Step

CMC, SBR, mannitol, and water were put into a planetary mixer and were kneaded with each other. As a result, a first mixture was obtained. At this time, the mixing amounts of solid components in the first mixture were adjusted as follows: CMC (1 part by mass), SBR (1 part by pass), and mannitol (1 part by mass) with respect to 100 parts by mass of the negative electrode active material.

1-3. Second Kneading Step

Natural graphite (100 parts by mass) was put into the planetary mixer, and the first mixture and the natural graphite were kneaded with each other to obtain a second mixture.

1-4. Dilution-Dispersion Step

Water was additionally added to the planetary mixer, and the components were kneaded with each other. As a result, a negative electrode mixture paste was obtained. The addition amount of water was adjusted such that the solid content proportion of the negative electrode mixture paste was 50 mass %.

1-5. Application Step

Using a die coater, the negative electrode mixture paste was applied to one main surface of the Cu foil. Next, the paste coating film was dried in a hot air drying furnace. As a result, a negative electrode mixture layer was formed.

Using the same method as described above, a negative electrode mixture layer was formed on the other main surface of the Cu foil. Using a rolling mill, the negative electrode mixture layer was rolled. The negative electrode mixture layer and the Cu foil were processed to have a predetermined dimension. As a result, the negative electrode 20 shown in FIG. 3 was obtained. The respective dimensions shown in FIG. 3 were as follows.

Width W22 of negative electrode mixture layer 22: 60.9 mm

Width W21 of portion Ep where current collector was exposed: 20.0 mm

Thickness of negative electrode mixture layer 22: 100 μm

2. Positive Electrode Preparation Step

2-1. Preparation Step

The following materials were prepared.

Positive electrode active material: LiNi_{1/3}Co_{1/3}Mn_{1/3}O₂

Conductive material: acetylene black

Binder: PVDF

Solvent: NMP

Positive electrode current collector: Al foil (thickness: 20 μm, width: 78.0 mm).

2-2. Kneading Step

LiNi_{1/3}Co_{1/3}Mn_{1/3}O₂, acetylene black, PVDF, and NMP were put into the planetary mixer and were kneaded with each other. As a result, a positive electrode mixture paste was obtained.

2-3. Application Step

The positive electrode mixture paste was applied to both main surfaces of the Al foil. Next, the paste coating film was dried in a hot air drying furnace. As a result, a positive electrode mixture layer was formed. Using a rolling mill, the positive electrode mixture layer was rolled. The positive electrode mixture layer and the Al foil were processed to have a predetermined dimension. As a result, the positive electrode 10 shown in FIG. 5 was obtained. The respective dimensions shown in FIG. 5 were as follows.

Width W12 of positive electrode mixture layer 12: 58.0 mm

Width W11 of portion Ep where current collector was exposed: 20.0 mm

3. Electrode Group Preparation Step

A microporous membrane separator (width: 63.0 mm) formed of PE was prepared. As shown in FIG. 6, the positive electrode 10 and the negative electrode 20 were arranged to face each other with the separators 40 interposed therebetween. The separators 40, the positive electrode 10, and the negative electrode 20 were wound around the winding axis AW. As a result, an elliptical wound body was obtained. Using a flat pressing machine, the wound body was formed into a flat shape to obtain the electrode group 80.

4. Case Accommodation Step

The square external case 50 was prepared. The external dimension of the external case 50 was length 75 mm×width 120 mm×depth 15 mm. The thickness of a side wall of the external case 50 was 1 mm. The positive electrode terminal 70 and the negative electrode terminal 72 provided on the sealing plate 54 were connected to the electrode group 80. As shown in FIG. 8, the electrode group 80 was accommodated in the case body 52. The case body 52 and the sealing plate 54 were joined to each other through laser welding.

5. Liquid Injection Step

LiPF6 was dissolved in a nonaqueous solvent (EC:EMC:DEC=3:5:2 (volume ratio)) to prepare an electrolytic solution. The concentration of LiPF₆ was 1.0 mol/L. The electrolytic solution was injected through the liquid injection hole provided on the external case 50.

6. Initial Charging and Discharging

First, the battery was charged at a current value of 1 C until the voltage reached 4.1 V. Next, the battery was discharged at a current value of ⅓ C until the voltage reached 3.0 V. Here, the unit “C” for the current value refers to the current value at which the rated capacity of a battery is completely discharged in 1 hour.

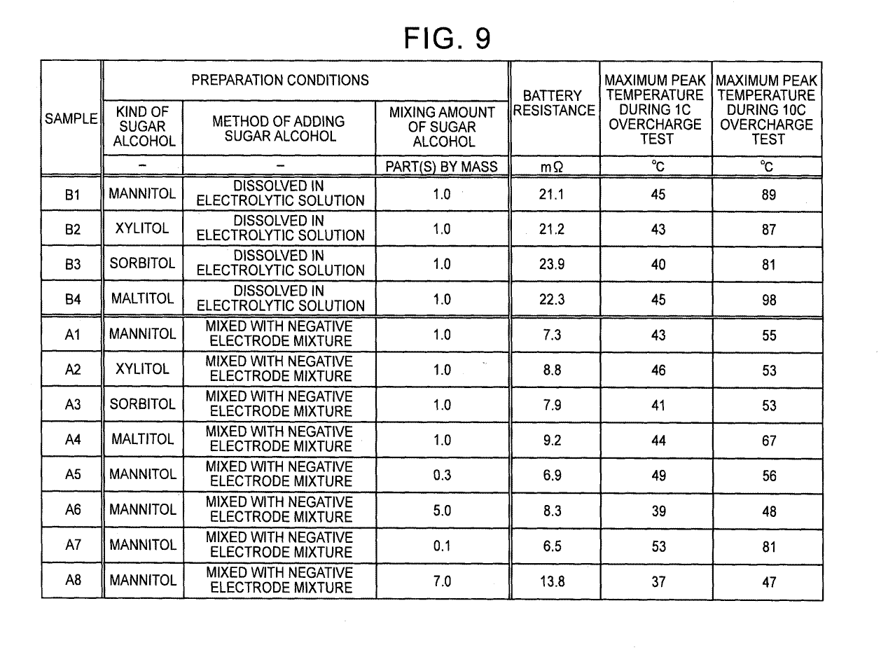

In this way, a nonaqueous electrolyte secondary battery according to Sample A1 was obtained. Preparation conditions of Sample A1 are shown in the table of FIG. 9. Numerical values shown in “Mixing Amount of Sugar Alcohol” of FIG. 9 are represented by part(s) by mass with respect to 100 parts by mass of the negative electrode active material.

[Samples A2 to A4]

Samples A2 to A4 were obtained using the same method as in Sample A1, except that xylitol, sorbitol, and maltitol were used as shown in FIG. 9 instead of mannitol.

[Samples A5 to A8]

Samples A5 to A8 were obtained using the same method as in Sample A1, except that the mixing amount of mannitol was changed as shown in FIG. 9.

[Sample B1]

In Sample B1, a negative electrode mixture paste was prepared as follows. Natural graphite (100 parts by mass), CMC (1 part by mass), SBR (1 part by mass), and water were put into a planetary mixer and were kneaded with each other. Next, water was additionally put into the planetary mixer, and the components were kneaded with each other to obtain a negative electrode mixture paste. The solid content proportion of the negative electrode mixture paste was 50 mass %.

In Sample B1, mannitol was further added to the electrolytic solution prepared above in “5. Liquid Injection”. The addition amount of mannitol in the battery was set as 1 part by mass with respect to 100 parts by mass of the negative electrode active material. Sample B1 was obtained using the same method as in Sample A1, except for the above-described configurations.

[Samples B2 to B4]

Samples B2 to B4 were obtained using the same method as in Sample B1, except that xylitol, sorbitol, and maltitol were used as shown in FIG. 9 instead of mannitol.

[Evaluation]

Each of the samples was evaluated as follows.

1. Distribution of Sugar Alcohol in Negative Electrode Mixture Layer

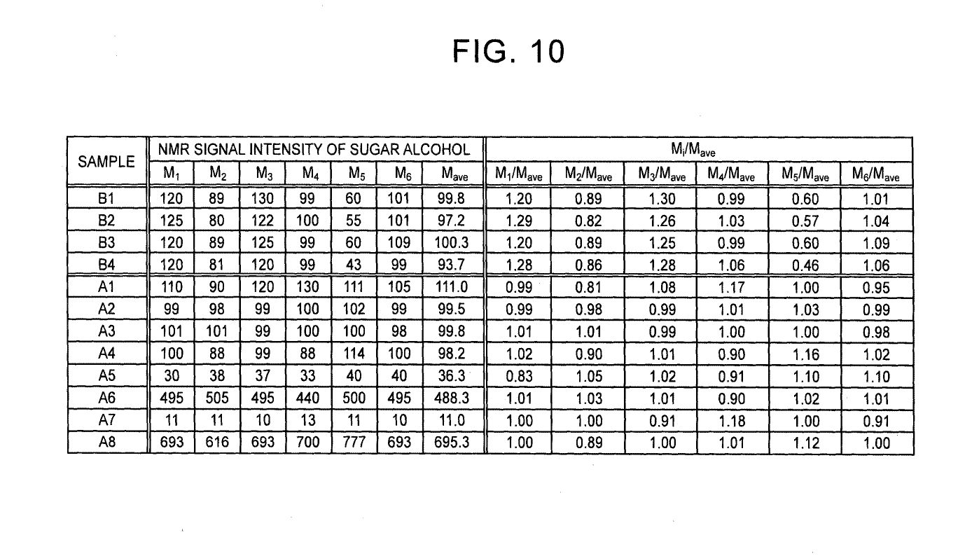

After initial charging and discharging, the battery having a voltage of 3.0 V was disassembled to extract the electrode group. A rectangular measurement sample was cut out from a region R0 shown in FIG. 6. A section in the thickness direction was obtained from the measurement sample. Using the above-described method, the NMR signal intensity of the sugar alcohol was measured to calculate Mᵢ/Mₐᵥₑ. The results are shown in FIG. 10.

2. Battery Resistance

The state of charge (SOC) of the battery was adjusted to 60% at 25° C. Pulse discharging was performed under conditions of 250 A (10 C)×10 seconds to measure a voltage drop amount. The IV resistance was calculated based on a relationship between the voltage drop amount and the current value. This measurement was performed on 10 batteries for each of the samples, and the average value was calculated. The results are shown in FIG. 9.

3. 1 C Overcharge Test

The battery was charged to 4.5 V at a constant current value of 25 A (1 C). At this time, the maximum peak temperature was measured using a thermocouple attached to a side surface of the battery. The results are shown in FIG. 9.

4. 10 C Overcharge Test

The maximum peak temperature was measured using the same method as in “1 C overcharge test”, except that the current value was changed to 250 A (10 C). The results are shown in FIG. 9.

[Results and Discussion]

1. Samples B1 to B4

As shown in FIG. 9, in Samples B1 to B4, an increase in battery resistance was observed. The reason for this is presumed to be as follows: the sugar alcohol was added to the electrolytic solution, the sugar alcohol permeated into the positive electrode mixture layer, and thus a resistance film was formed.

In Sample B1 to B4, the safety during the 1 C overcharge test was high. However, during the 10 C overcharge test, an increase in temperature was observed. It can be understood that the reason for this is the distribution of the sugar alcohol in the negative electrode mixture layer. As shown in FIG. 10, in Samples B1 to B4, the distribution of the sugar alcohol in the section of the negative electrode mixture layer in the thickness direction was non-uniform. That is, in Samples B1 to B4, M₅/Mₐᵥₑ was 0.8 or less, Mᵢ/Mₐᵥₑ and M₃/Mₐᵥₑ were 1.2 or more. The reason for this is presumed to be that the electrolytic solution and the sugar alcohol were not likely to permeate into the negative electrode mixture layer. In addition, it is presumed that, since the abundance of the sugar alcohol in a position near the measurement region R5 was small, lithium metal was not able to be sufficiently inactivated during high-rate overcharge.

2. Samples A1 to A7

In Samples A1 to A7, an increase in battery resistance was able to be suppressed. The reason for this is presumed to be that, in these samples, the sugar alcohol was added during the preparation of the negative electrode mixture paste, and thus substantially no sugar alcohol was present in the positive electrode mixture layer.

In Samples A1 to A7, even during the 10 C overcharge test, an increase in temperature was small. As shown in FIG. 10, in Samples A1 to A7, Mᵢ/Mₐᵥₑ was more than 0.8 and less than 1.2. That is, it can be said that the sugar alcohol was uniformly distributed in the negative electrode mixture layer. It is presumed that, due to the above-described reason, high safety was exhibited even during high-rate overcharge.

3. Kind of Sugar Alcohol

As shown in FIG. 9, when mannitol, xylitol, sorbitol, or maltitol was used, the improvement of safety during overcharge was verified. Therefore, the sugar alcohol may be at least one selected from the group consisting of mannitol, xylitol, sorbitol, and maltitol.

As a result of comparing Samples A1 to A4 to each other, it was found that, when mannitol, xylitol, or sorbitol was used, the effect was high. Therefore, it is preferable that the sugar alcohol is at least one selected from the group consisting of mannitol, xylitol, and sorbitol.

4. Mixing Amount of Sugar Alcohol

As shown in FIG. 9, when the mixing amount of the sugar alcohol was within a range of 0.1 parts by mass to 7.0 parts by mass with respect to 100 parts by mass of the negative electrode active material, the improvement of safety during overcharge was verified. In particular, within a range of 0.3 parts by mass to 5.0 parts by mass, the effect was high. Therefore, the mixing amount of the sugar alcohol may be 0.1 parts by mass to 7.0 parts by mass with respect to 100 parts by mass of the carbon-based negative electrode active material. It is preferable that the mixing amount is 0.3 parts by mass to 5.0 parts by mass.

The above-described method of manufacturing a nonaqueous electrolyte secondary battery includes: a kneading step of kneading a carbon-based negative electrode active material, a binder, and a sugar alcohol with each other to form a negative electrode mixture paste; and an application step of applying the negative electrode mixture paste to a negative electrode current collector to form a negative electrode mixture layer. It can be verified from the above description that, with the above-described method, an increase in battery resistance can be suppressed while improving safety during overcharge.

In the nonaqueous electrolyte secondary battery, when a section of the negative electrode mixture layer in a thickness direction is divided into six measurement regions by trisecting the negative electrode mixture layer in a width direction and further bisecting the negative electrode mixture layer in the thickness direction, all the measurement regions satisfy the expression (I). It can be verified from the above description that, in the above-described nonaqueous electrolyte secondary battery, the safety during overcharge is high.

Hereinabove, the embodiment and the examples of the invention have been described. It is primarily intended that the configurations of the embodiment and the examples can be appropriately combined.

The embodiment and Examples disclosed herein are merely exemplary in all respects and are not particularly limited.

What is claimed is:

1. A method of manufacturing a nonaqueous electrolyte secondary battery, the method comprising:
a kneading step of kneading a carbon-based negative electrode active material, a binder, and a sugar alcohol with each other to form a negative electrode mixture paste; and
an application step of applying the negative electrode mixture paste to a negative electrode current collector to form a negative electrode mixture layer.

2. The method according to claim 1, wherein
the sugar alcohol is at least one selected from the group consisting of mannitol, xylitol, sorbitol, and maltitol.

3. The method according to claim 1, wherein
a mixing amount of the sugar alcohol is 0.1 parts by mass to 7.0 parts by mass with respect to 100 parts by mass of the carbon-based negative electrode active material.

4. The method according to claim 1, wherein
the kneading step includes:
a first kneading step of kneading the binder, the sugar alcohol, a thickener, and a solvent with each other to obtain a first mixture;
a second kneading step of kneading the first mixture and the carbon-based negative electrode active material with each other to obtain a second mixture; and
a dilution-dispersion step of adding the solvent to the second mixture and kneading the solvent and the second mixture with each other to obtain the negative electrode mixture paste.

5. A nonaqueous electrolyte secondary battery comprising:
a negative electrode current collector; and
a negative electrode mixture layer that is formed on the negative electrode current collector, wherein
the negative electrode mixture layer contains a carbon-based negative electrode active material, a binder, and a sugar alcohol, and
when a section of the negative electrode mixture layer in a thickness direction is divided into six measurement regions by trisecting the negative electrode mixture layer in a width direction and further bisecting the negative electrode mixture layer in the thickness direction, all the measurement regions satisfy the following expression (I):
0.8<Mᵢ/Mₐᵥₑ<1.2 (I)
where i represents an integer of 1 to 6,
Mᵢ represents an NMR signal intensity of the sugar alcohol in each of the measurement regions, and
Mₐᵥₑ represents an average value of M₁, M₂, M₃, M₄, M₅, and M₆.

6. The nonaqueous electrolyte secondary battery according to claim 5, wherein
the average value is 10 to 700.
